(19) United States
(12) Patent Application Publication
(10) Pub. No.: US 2026/0131487 A1
(43) Pub. Date: May 14, 2026

(54) System and Method for Moving a Mill Liner within a Mill

(71) Applicant: Russell Mineral Equipment Pty Ltd, Toowoomba Queensland (AU)

(72) Inventors: Steven Smith, Toowoomba, Queensland (AU); Wayne Herbertson, Toowomba Queensland (AU)

(73) Assignee: Russell Mineral Equipment Pty Ltd, Toowoomba Queensland (AU)

(21) Appl. No.: 19/490,254

(22) PCT Filed: Apr. 26, 2024
(86) PCT No.: PCT/AU2024/050401

§ 371 Date: Jan. 12, 2026

(30) Foreign Application Priority Data
Jun. 5, 2023 (AU) 2023901769

(51) Int. Cl. B25J 15/10; B02C 23/00

(52) U.S. Cl. CPC B25J 15/10; B02C 23/00; B02C 2210/02

(57) ABSTRACT

A system for use in moving a mill liner within a mill, the system including: a liner gripping device including: a device frame; one or more gripping members that are moveable relative to the device frame; and an actuator that is operable to move the one or 2024/250055 more gripping members for gripping a mill liner in use; and an interface for detachably coupling the liner gripping device to a distal end of a mill relining machine to allow the liner gripping device to be moved using the mill relining machine, the interface being attached to the device frame and configured so that the distal end of the mill relining machine engages with the interface to transmit forces between the mill relining machine and the liner gripping device in use.

### BACKGROUND OF THE INVENTION

The present invention relates to a system and method for moving a mill liner within a mill, such as an ore grinding mill, being particularly suitable for removing a mill liner that is worn and needs replacing.

### DESCRIPTION OF THE PRIOR ART

Mill liners are sacrificial wear components used to protect the shell of an ore grinding mill from damage and to provide a mechanism to lift the ore charge during mill operation, for grinding the ore charge down to the required size. The mill liners need to be replaced at regular intervals (generally 3 to 6 months), because the ore charge wears the liners down to the point where the mill shell is at risk of damage, or the grinding process efficiency has reduced significantly.

Worn mill liners need to be removed from inside the mill prior to the introduction and installation of new mill liners. The inside of the mill is classified as a confined space, the floor of the mill is uneven, there is poor visibility, there is the potential for falling objects to strike the operator (steel balls and rocks wedged in the liners), the atmosphere is hot and humid, communication is difficult, and the operators are in close proximity to working machinery and suspended loads.

Dislodging mill liners from the mill shell and manipulating mill liners prior to lifting and removing them has often been achieved via the misuse of lifting machinery. Personnel position themselves inside the mill and in close proximity to hydraulically powered lifting machinery to enable them to complete the connection between the mill liners and the lifting machinery. The removal of worn liners generates hazards to personnel that need to be controlled via the methodology employed to connect to, and relocate the liners.

The machine used to reline the mill is typically referred to as a mill relining machine (MRM), and will often include a grapple tool that is specifically designed to engage with lifting lugs and/or other features of the liner profile of a new mill liner, to allow it to be lifted into position for installation.

However, by the time a mill liner needs to be removed, it has worn significantly from its original shape. All lifting lugs and to a large extent, much of the liner profile is worn away. The worn profile of the liner is variable and unpredictable such that the MRM cannot engage with a worn liner as it would engage with a new liner. Instead, slings, chains or the like are often used by operators inside the mill to attach the worn liners to the MRM. The worn liners may then be lifted using the MRM and placed on a liner cart and driven out of the mill, although the means of attachment of the worn liners to the MRM is contrary to the original design intent of the MRM and its grapple tool.

Misuse of lifting machinery most commonly leads to machine damage, repair costs and lost income due to down time. Personnel inside a mill during the dislodging, connection and lifting of mill liners are subject to considerable hazards that may lead to serious injury or death.

It would therefore be advantageous to develop a system and method for moving a mill liner within a mill, especially for removal of a worn mill liner, that may remove the need for misuse of lifting machinery, and may remove the need for operators to be inside the mill in order to improve safety and mitigate the risk of potential accidents.

It is against this background, and the problems and difficulties associated therewith, that the present invention has been developed.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY OF THE PRESENT INVENTION

In one broad form an aspect of the present invention seeks to provide a system for use in moving a mill liner within a mill, the system including: a liner gripping device including: a device frame; one or more gripping members that are moveable relative to the device frame; and an actuator that is operable to move the one or more gripping members for gripping a mill liner in use; and an interface for detachably coupling the liner gripping device to a distal end of a mill relining machine to allow the liner gripping device to be moved using the mill relining machine, the interface being attached to the device frame and configured so that the distal end of the mill relining machine engages with the interface to transmit forces between the mill relining machine and the liner gripping device in use.

In one embodiment, the distal end of the mill relining machine includes a grapple tool having liner engaging elements configured for engaging with a new mill liner, the interface being configured so that the liner engaging elements of the grapple tool engage with the interface.

In one embodiment, the liner engaging elements of the grapple tool include liner engagement pins for engaging with lifting lugs of a new mill liner, the interface including sockets configured for receiving the liner engagement pins to thereby allow the grapple tool to at least partially engage with the interface.

In one embodiment, the liner engaging elements of the grapple tool include a pair of liner engagement pins and a reaction foot for engaging with a surface of a new mill liner, the interface including a pair of sockets for receiving the pair of liner engagement pins and a first reaction surface for engaging with the reaction foot of the grapple tool.

In one embodiment, the grapple tool further includes a rigid surface opposing the reaction foot, the interface further including a second reaction surface for engaging with the rigid surface of the grapple tool.

In one embodiment, the liner engaging elements of the grapple tool include two pairs of liner engagement pins, the interface including two pairs of sockets for receiving the two pairs of liner engagement pins of the grapple tool.

In one embodiment, the liner gripping device is operable to provide an adjustable gripping width for producing a positive grip around worn mill liners having variable shapes.

In one embodiment, the one or more gripping members include opposing gripping members that are pivotally coupled to the device frame and moveable between a closed position and an open position.

In one embodiment, the gripping members include a first gripping member including two or more fingers and a second gripping member including one or more fingers that interlock with the fingers of the first gripping member, when the gripping members are in the closed position.

In one embodiment, one of: the first gripping member includes two fingers and the second gripping member includes one finger; the first gripping member includes two fingers and the second gripping member includes two fingers; and the first gripping member includes three fingers and the second gripping member includes two fingers.

In one embodiment, each finger includes a liner engaging portion formed from a different material compared to a material forming the fingers.

In one embodiment, the fingers are formed from steel and the liner engaging portions are formed from a material that is substantially softer compared to steel.

In one embodiment, the liner engaging portions are formed from a resilient material.

In one embodiment, each liner engaging portion is provided as one of: a component that is attached to a respective finger; a sleeve that is fitted around a respective finger; and a coating that is applied to a respective finger.

In one embodiment, each liner engaging portion is provided as a sacrificial component that can be replaced when worn.

In one embodiment, the one or more gripping members are at least one of: adjustable in shape to suit mill liners of different shapes; and interchangeable to allow different the use of different gripping members to suit mill liners of different shapes.

In one embodiment, the actuator of the liner gripping device is hydraulically powered and is supplied with hydraulic fluid that is diverted from a hydraulic actuation function of the mill relining machine.

In one embodiment, the actuator of the liner gripping device is hydraulically powered and is supplied with hydraulic fluid that is diverted from a hydraulic actuation function of the grapple tool being for causing movement of the liner engaging pins for engaging with a new mill liner.

In one embodiment, the interface includes a rotator that is operable to rotate the liner gripping device relative to the mill relining machine.

In one embodiment, the rotator is hydraulically powered and is supplied with hydraulic fluid that is diverted from a hydraulic rotation function of one of the mill relining machine.

In one embodiment, the system includes one or more hydraulic counterbalance valves to prevent unintentional hydraulic movement of the liner gripping device in use.

In one embodiment, the system includes a first counterbalance valve connected to the actuator to ensure that, in the event of hydraulic hose failure, the gripping members can maintain a grip on a mill liner, unless hydraulic input pressure is applied by the operator.

In one embodiment, the first counterbalance valve is connected to the actuator via steel hydraulic tubing to protect against potential hydraulic hose failure downstream from the first hydraulic counterbalance valve.

In one embodiment, the interface includes a hydraulically powered rotator that is operable to rotate the liner gripping device relative to the mill relining machine, the system including a second counterbalance valve connected to the rotator to ensure that, in the event of hydraulic hose failure, the liner gripping device and any mill liner gripped by the gripping members cannot rotate, unless hydraulic input pressure is applied by the operator.

In one embodiment, the system includes at least one of: one or more hydraulic fittings that are configured to be selectively connected to and disconnected from a hydraulic system of the mill relining machine to provide hydraulic power to at least the actuator; and one or more in line hydraulic filter screens for substantially preventing contamination of the hydraulic system due to connection and disconnection of the hydraulic fittings.

In one embodiment, the system further includes a liner dislodging member for dislodging a mill liner from the mill.

In one embodiment, the interface includes first and second mounting blocks for installing a liner bolt for use as the liner dislodging member.

In one embodiment, the first mounting block is configured to receive a threaded portion of a liner bolt and the second mounting block is configured to receive a head of the liner bolt to thereby retain the liner bolt relative to the liner gripping device.

In one embodiment, the liner gripping device and the interface are configured to be stored on a transport tray when detached from the mill relining machine.

In one broad form an aspect of the present invention seeks to provide a method for moving a mill liner within a mill, the method being performed using a system including a liner gripping device and an interface that is used to detachably couple the liner gripping device to a distal end of a mill relining machine, whereby the distal end of the mill relining machine engages with the interface to transmit forces between the mill relining machine and the liner gripping device, the method including: using the mill relining machine to position the liner gripping device relative to a mill liner within the mill; operating an actuator of the liner gripping device to move one or more gripping members of the liner gripping device for gripping the mill liner; and using the mill relining machine to move the liner gripping device and the mill liner gripped by the one or more gripping members within the mill.

In one embodiment, the mill liner is a worn mill liner and the method includes moving the worn mill liner to facilitate removal of the worn mill liner from the mill.

In one embodiment, the actuator of the liner gripping device is hydraulically powered and is supplied with hydraulic fluid by diverting hydraulic flow from a hydraulic actuation function of the mill relining machine, the method including operating the actuator using the hydraulic actuation function.

In one embodiment, the method further includes operating a rotator of the system to rotate the gripping members relative to the worn liner.

In one embodiment, the rotator of the system is hydraulically powered and is supplied with hydraulic fluid by diverting hydraulic flow from a hydraulic rotation function of the mill relining machine, the method including operating the rotator using the hydraulic rotation function.

In one embodiment, the distal end of the mill relining machine includes a grapple tool having liner engaging elements configured for engaging with a new mill liner, the method including causing the liner engaging elements of the grapple tool to engage with the interface to couple the liner gripping device to the mill relining machine.

In one embodiment, the liner gripping device and the interface are configured to be stored on a transport tray when detached from the mill relining machine, the method including, prior to using the mill relining machine to position the liner gripping device: moving the liner gripping device and interface into the mill on the transport tray; using the mill relining machine to position the grapple tool relative to the interface; and causing the liner engaging elements of the grapple tool to engage with the interface to couple the liner gripping device to the mill relining machine.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

Various examples and embodiments of the present invention will now be described with reference to the accompanying drawings, in which:—

FIG. 1A is a first perspective view of an example of a system for moving a mill liner within a mill;

FIG. 1B is a second perspective view of the system of FIG. 1A;

FIG. 2 is a perspective view of a grapple tool of the mill relining machine of FIG. 1A;

FIG. 3A is a perspective view of a liner gripping device and an interface of the system of FIG. 1A, with gripping members in a closed position;

FIG. 3B is a perspective view of the liner gripping device and the interface of FIG. 3A, with gripping members in an open configuration;

FIG. 3C is a side view of the liner gripping device and the interface of FIG. 3A;

FIG. 3D is a top view of the liner gripping device and the interface of FIG. 3A;

FIG. 3E is end view of the liner gripping device and the interface of FIG. 3A;

FIG. 4 is a perspective view of the liner gripping device and the interface of FIG. 3A, with a liner bolt fitted for use as a liner dislodging member;

FIG. 5 is a perspective view of a liner gripping device and another example of an interface that includes a rotator;

FIG. 6 is a perspective view of a transport tray;

FIG. 7 is a perspective view of the liner gripping device and the interface of FIG. 3A fitted to the transport tray of FIG. 6;

FIG. 8 is a perspective view of an example of a six-port selector valve for use with the system of FIGS. 1A and 1B;

FIG. 9 is an example of a hydraulic circuit for use with the system of FIGS. 1A and 1B; and

FIG. 10 is an example of a hydraulic circuit for use with another example of the system including a rotator and pressure build-up protection.

### DETAILED DESCRIPTION OF THE PREFERRED EMBODIMENTS

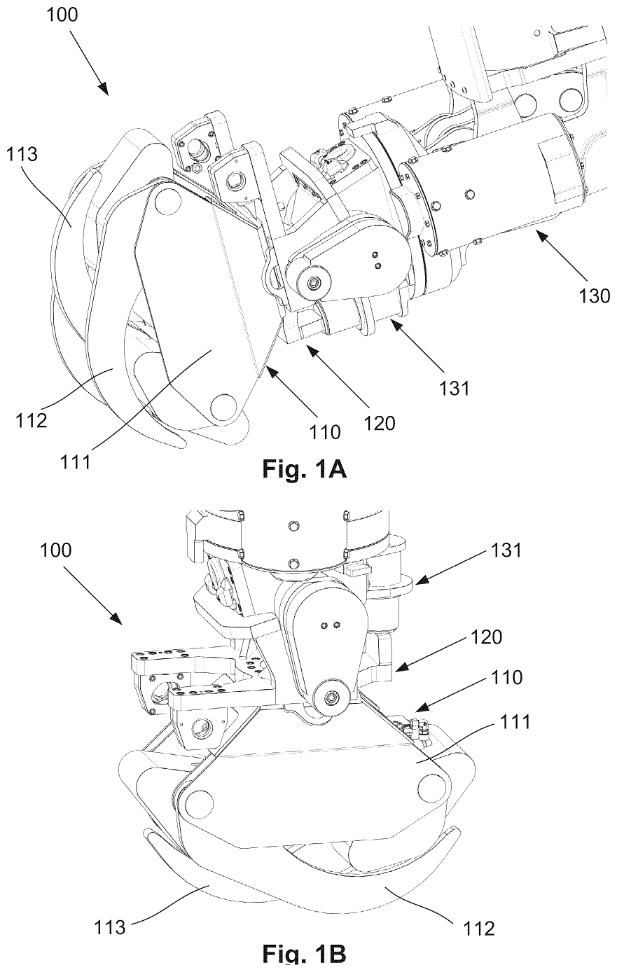

An example of a system for use in moving a mill liner within a mill will now be described with reference to FIGS. 1A and 1B.

In broad terms, the system 100 includes a liner gripping device 110 and an interface 120 for detachably coupling the liner gripping device 110 to a distal end mill relining machine 130 (only the distal end portion of the mill relining machine 130 is shown in FIG. 1A) to allow the liner gripping device 110 to be moved using the mill relining machine 130.

The liner gripping device 110 includes a device frame 111, one or more gripping members 112, 113 that are moveable relative to the device frame 111, an actuator (not shown) that is operable to move the one or more gripping members 112, 113 for gripping a mill liner in use. The interface 120 is attached to the device frame 111 and configured so that the distal end of the mil relining machine 130 engages with the interface 120 to transmit forces between the mill relining machine 130 and the liner gripping device 110 in use.

The system 100 is specifically configured to allow the distal end of the mill relining machine 130 to securely engage with the interface 120 to thereby allow the liner gripping device 110 to be moved using the mill relining machine 130, for gripping, lifting and moving a mill liner within the mill. A suitably configured liner gripping device 110 can provide an adjustable gripping width capable of producing a positive grip around variable shaped mill liners, to thereby accommodate a range of different mill liners in different states of wear, especially worn mill liners requiring removal from the mill.

It will be appreciated that the system 100 provides a solution for allowing an existing mill relining machine 130 to be used in the removal of worn mill liners, without the downsides associated with traditional techniques involving manually attaching worn mill liners using slings, chains or the like. Unlike conventional attachment techniques, the system 100 can be operated to position the liner gripping device 110 and use it to grip a worn mill liner without having to resort to misuse of lifting machinery and without the need for personnel to be inside the mill to facilitate the attachment of the worn mill liner.

Embodiments of the system 100 can also provide improved reline speed. With a trained and competent operator, the speed at which worn mill liners can be removed from the mill will be equal to or faster than traditional removal methods with slings and chains.

In addition, the interface 120 can be designed to allow the liner gripping device 110 to be more securely and accurately positioned in relation to the mill relining machine 130, such that the system 100 can be operated to precisely move the liner gripping device 110 and any worn mill liner gripped by its gripping members 112, 113 to enable more efficient and safe removal from the mill compared to traditional techniques.

Although the system 100 is particularly well suited to use in removing worn mill liners from a mill using the liner gripping device 110, it should be understood that the system 100 can also be useful for a range of other operations that require movement of a mill liner within a mill.

A range of further preferred or optional features of embodiments of the system 100 will now be outlined.

In the example shown in FIGS. 1A and 1B, the distal end of the mill relining machine 130 includes a grapple tool 131 having liner engaging elements configured for engaging with a new mill liner (during ordinary use of the mill relining machine 130 for installing new mill liners). Accordingly, in this embodiment of the system, the interface 120 may be configured so that the liner engaging elements of the grapple tool 131 engage with the interface 120, to thereby transmit forces between the mill relining machine 130 and the liner gripping device 110.

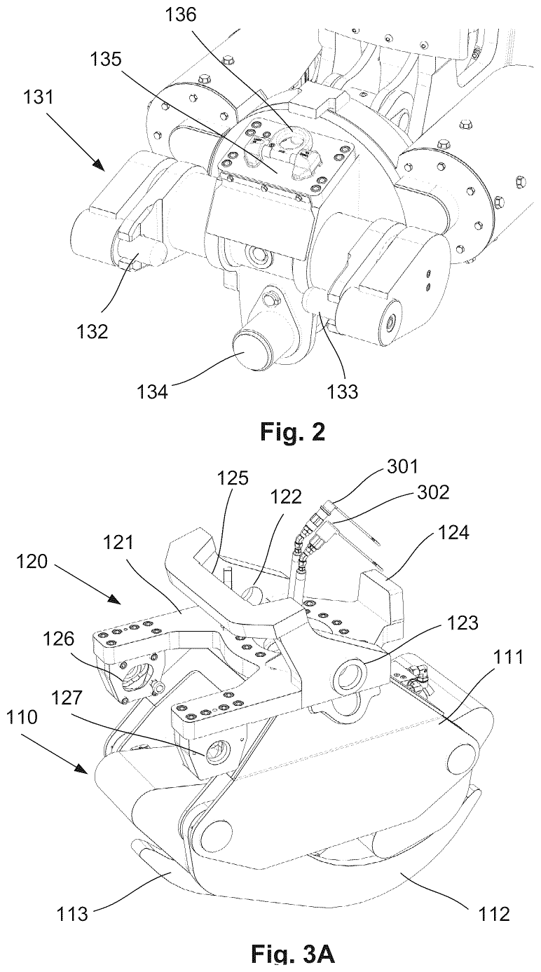

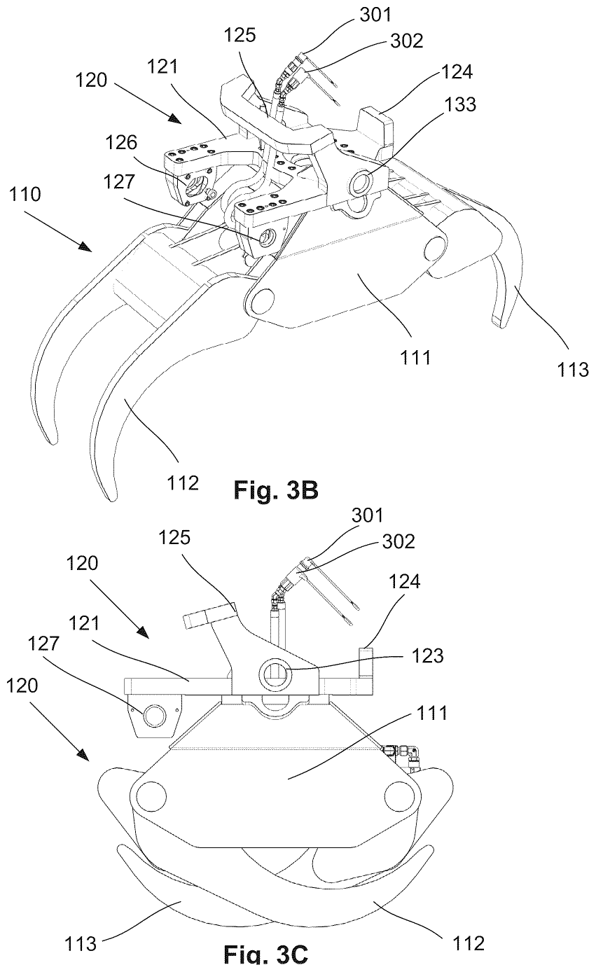

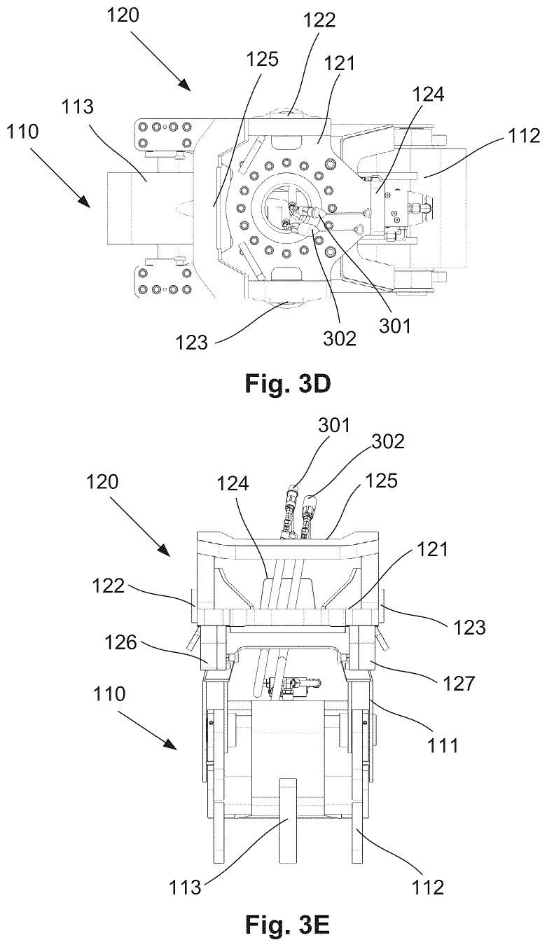

Further details of the grapple tool 131 of the mill relining machine 130 of FIGS. 1A and 1B can be seen in FIG. 2, and further features of the liner gripping device 110 and the interface 120 detached from the grapple tool 131 can be seen in FIGS. 3A to 3E.

In this embodiment, the system 100 utilises existing liner engaging elements of the grapple tool 131 to detachable couple with the interface 120. Rather than using the liner engaging elements of the grapple tool 131 to engage with features of a new mill liner, the liner engaging elements of the grapple tool 131 can instead be used to provide a secure engagement with the interface 120 to thereby allow the liner gripping device 110 to be moved using the mill relining machine 130. This can enable gripping, lifting and removing a worn mill liner which may no longer have features that can be engaged using the liner engaging elements of the grapple tool 131.

The liner engaging elements of the grapple tool 131 may include liner engagement pins 132, 133 that are designed for engaging with lifting lugs of a new mill liner, and in such cases the interface 120 may include sockets 122, 123 configured for receiving the liner engagement pins 132, 133 to thereby allow the grapple tool 131 to at least partially engage with the interface 120.

It will be appreciated that the sockets 122, 123 may be configured so that the liner engaging pins 132, 133 can engage with the sockets 122, 123 in a similar manner as they would engage with the lifting lugs of a new mill liner. In other words, the sockets 122, 123 may be provided with similar sizes and positioning as the lifting lugs, to allow the grapple tool 131 to be coupled with the interface 120 using similar operations as would be carried out when engaging with a new mill liner to be installed.

In this example, the liner engaging elements of the grapple tool 131 include a pair of liner engagement pins 132, 133 and a reaction foot 134 that is designed for engaging with a surface of a new mill liner, and the interface 120 includes a pair of sockets 122, 123 for receiving the pair of liner engagement pins 132, 133 along with a first reaction surface 124 for engaging with the reaction foot 134 of the grapple tool 131. When the grapple tool 131 is used to lift a new mill liner, the liner engagement pins 132, 133 are engaged with the lifting lugs of the new mill liner and the reaction foot 134 engages with a surface of the new mill liner to transfer moments generated by offset loading due to the weight of the new mill liner being lifted. The interface 120 allows the liner gripping device 110 to be coupled to the grapple tool 131 using a similar approach, which also allows the transfer of moments generated due to the weight of a worn mill liner gripped by the liner gripping device 110.

In this example, the grapple tool 131 further includes a rigid surface 135 opposing the reaction foot 134, and the interface 120 further includes a second reaction surface 125 for engaging with the rigid surface 135 of the grapple tool 131. In this case the rigid surface 135 is a top plate of the grapple tool 131 which may also be fitted with a lifting ring 136 that is traditionally used to assist with the slinging of worn liners from the mill. In any event, the engagement of the second reaction surface 125 with the rigid surface 135 opposing the reaction foot 134 allows the interface 120 to couple the liner gripping device 110 to the grapple tool 131 without allowing any rotation about the pair of liner engagement pins 132, 133. In particular, this allows the transfer of moments generated due to other forces that may be applied to the liner gripping device 110 during its operation, such as when the gripping members 112, 113 are being moved to grip a worn mill liner.

In this example, the interface 120 includes a mounting plate 121 that is attached to the device frame 111, with each of the sockets 122, 123 and reaction surfaces 124 and 125 being provided on structures that extend from the mounting plate 121. For example, the sockets 122, 123 may be provided on brackets extending from opposing sides of the mounting plate 121, the first reaction surface 124 may be provided on a flange at one end of the mounting plate 121 and the second reaction surface 125 may be provided on a rigid element that extends between the aforementioned brackets providing the sockets 122, 123. However, it will be appreciated that the specific design of the interface 120 will depend on the configuration of the liner gripping device 110 and the grapple tool 131, structural requirements, and the like.

It will be understood that the liner gripping device 110 can be securely coupled to the grapple tool 131 by configuring the interface 130 so that the pair of liner engagement pins 132, 133 engages with the pair of sockets 122, 123, the reaction foot 134 engages with the first reaction surface 124, and the rigid surface 135 opposing the reaction foot 134 engages with the second reaction surface 125.

The primary engagement between the interface 130 and the grapple tool 131 is achieved via engagement of the liner engagement pins 132, 133 with the sockets 122, 123, while the reaction surfaces 124, 125 on the interface 120 maintain the position of the liner gripping device 110 relative to the mill relining machine 130 and its grapple tool 131 and allow moments to be transmitted between the liner gripping device 110 and the mill relining machine 130. The reaction surfaces 124, 125 of the interface 120 which come into contact with points on the grapple tool 131 should be selected to adequately transmit driving forces to manoeuvre the liner gripping device 110.

However, it should be appreciated that different embodiments of the system 100 may use different arrangements for coupling the liner gripping device 110 to the grapple tool 131. The coupling arrangement will depend to some extent on the particular configuration of the grapple tool 131 for engaging with new mill liners.

For instance, in an alternative example, the liner engaging elements of the grapple tool 131 may include two pairs of liner engagement pins, and the interface 120 may include two corresponding pairs of sockets for receiving the two pairs of liner engagement pins of the grapple tool 131. The four liner engagement pins would be capable of transmitting all forces from the grapple tool 131 to the liner gripping device 110, such that no other reaction surfaces are required.

In other examples, the grapple tool 131 may include different configurations of liner engaging elements, such as for engaging with a number of different surfaces of the new mill liners, and the interface 120 may include different configurations of reaction surfaces that are adapted to be engaged by the respective elements of the grapple tool 131.

Although the grapple tool 131 can provide a convenient means of engaging with the interface 120 for detachably coupling the liner gripping device 110 to the distal end of a mill relining machine 130, it should be understood that alternative embodiments of the system 100 may not require a grapple tool and may instead have the interface 120 configured so that other features of the distal end of the mill relining machine 130 engages with the interface 120, whilst still facilitating movement of the liner gripping device 110 and transmission of forces between the mill relining machine 130 and the liner gripping device 110 in use.

In one example, the grapple tool 131 may be removed and effectively replaced by the system 100, with the interface 120 being configured so that features of the distal end of the mill relining machine 130 that would normally engage with the grapple 131 may be used to engage with the interface 120 instead. In other examples, the interface 120 may be configured so that other existing features at the distal end of the mill relining machine 130 engage with the interface 120 to provide a secure connection. In yet other examples, the distal end of the mill relining machine 130 may be modified or additional components may be installed to facilitate the detachable coupling of the liner gripping device 110 to the distal end of the mill relining machine 130.

In any event, it should be appreciated that the connection between the mill relining machine 130 and the liner gripping device 110 using the interface 120 allows for direct translation of movement from the mill relining machine 130 to the liner gripping device 130 and its gripping members 131. The angle of mounting of the liner gripping device 120 in relation to the mill relining machine 130 is important for allowing the successful function of the system 100 inside a mill. Space to move and perform the system functions is limited inside a mill and depending upon the mill size can be inhibitive. Thus, the primary connection point between the interface 120 and the distal end of the mill relining machine 130, and the angle at which the liner gripping device 110 is positioned by the interface 120, must be carefully considered. The mill relining machine 130 has limits of motion for all axes of movement and requires careful positioning of the liner gripping device 110 to allow worn mill liners to be gripped and lifted from the mill charge, and to otherwise facilitate their removal from the mill, such as by placing the worn mill liners on to a liner cart, and dislodging of liners from the mill shell wall. The inability of the system 100 to perform these functions within the travel limits of the mill relining machine 130 would invalidate the solution.

The liner gripping device 110 is preferably operable to provide an adjustable gripping width for producing a positive grip around worn mill liners having variable shapes.

Suitable embodiments of the system 100 may utilise a commercially available claw mechanism to provide the liner gripping device 110, with the particular claw mechanism being selected to have an appropriate size and gripping performance to allow gripping of the mill liners commonly found in mills where the system will be used. It will be appreciated that different forms of the interface 120 may be provided to attach to different forms of the liner gripping device 110, depending on requirements, whilst providing the same interfacing features to allow the grapple tool 131 or other features at the distal end of the mill relining machine 100 to engage with the interface 120 in a secure manner as discussed above.

In the embodiment of the system 100 shown in FIGS. 1A and 1B, the liner gripping device 110 includes opposing gripping members 112, 113 that are pivotally coupled to the device frame 111 and moveable between a closed position as shown in FIG. 3A, and an open position as shown in FIG. 3B.

In some embodiments of the liner gripping device 110, the gripping members 112, 113 may include a first gripping member 112 including two or more fingers and a second gripping member 113 including one or more fingers that interlock with the fingers of the first gripping member 112, when the gripping members 112, 113 are in the closed position.

In the example of the liner gripping device 110 shown in FIGS. 3A to 3F, the first gripping member 112 includes two fingers and the second gripping member 113 includes one finger. Such a configuration of the liner gripping device 110 would generally provide the minimum amount of fingers to allow worn liners to be securely gripped by the liner gripping device 110 when provided in the form of a claw mechanism. However, this configuration is not essential and different numbers of fingers may be used depending on requirements. For example, the first gripping member 112 may include two fingers and the second gripping member 113 may include two fingers, or the first gripping member 112 may include three fingers and the second gripping member 113 may include two fingers. The number of fingers is not particularly limited although for practical reasons it may be preferred to provide fewer fingers to minimize the complexity of the liner gripping device 110.

It should be appreciated that the shape and profile of the fingers is not particularly limited, and may vary substantially compared to the depicted examples. Different finger shapes may allow for a more positive grip on some larger liners. Altering the finger shape may also make the tips of the fingers more effective at levering worn liners from the mill shell wall when they are stuck.

In some embodiments, each finger of the liner gripping device 110 may include a liner engaging portion formed from a different material compared to a material forming the fingers. For example, the fingers are commonly formed from steel, and the liner engaging portions may be formed from a material that is substantially softer compared to steel. For instance, the liner engaging portions may be formed from a resilient material such as rubber or the like. It will be appreciated that using a different material in the liner engaging portions of the fingers may help to improve the grip with the worn mill liners, which are typically formed from steel.

The liner engaging portions may be provided in a range of different forms depending on requirements. For example, each liner engaging portion may be provided as a component that is attached to a respective finger, a sleeve that is fitted around a respective finger, or a coating that is applied to a respective finger. The liner engaging portions may cover an internal surface of the finger, where it is likely to come into contact with a mill liner in use.

Each liner engaging portion may have a different shape or profile compared to the finger to which it has been attached, for instance to include an enlarged contact area or grip enhancing features for further improving the gripping performance of the liner gripping device 110. In some examples, the liner engaging portions may include abrasive, soft or jagged material to enhance the positive grip of the gripping members 112, 113.

In some implementations, each liner engaging portion may be provided as a sacrificial component that can be replaced when worn. It will be appreciated that suitable liner engaging portions can be applied to commercially available claw mechanisms to improve its capability for gripping worn mill liners without having to modify the design of the liner gripping device 110. This may be especially desirable when using a commercially available claw mechanism to provide the liner gripping device 110.

However, it should be appreciated that suitable embodiments of the liner gripping device 110 are not limited to those provided with opposing gripping members 112, 113 such as those provided in the form of a claw mechanism or the like. In some examples, the liner gripping device 110 may include a single gripping member that can be moved relative to a fixed member of the liner gripping device 110, such as a portion of the device frame 111, to allow for secure gripping of a mill liner. The actuator of the liner gripping device 110 may be used to pivotally rotate or slide the gripping member towards the fixed member to thereby move from an open position to a closed position, to grip mill liners or variable states of wear. In other examples, the liner gripping device 110 could include a combination of pivoting and sliding gripping members to provide suitable gripping functionality.

In some implementations of the liner gripping device 110, the one or more gripping members 112, 113 may be adjustable in shape to suit mill liners of different shapes, or may be interchangeable to allow different the use of different gripping members 112, 113 to suit mill liners of different shapes. It will be appreciated that this can allow for even further improved flexibility for handling a wide range of different mill liners in varying states of wear.

In some implementations of the system 100, the actuator of the liner gripping device 110 may be hydraulically powered, although this is not essential and in some other implementations the actuator may be powered in other ways, such as electrically or pneumatically. In hydraulically powered embodiments, it may be desirable to have the actuator supplied with hydraulic fluid that is diverted from a hydraulic actuation function of the mill relining machine 130. In examples where the interface 120 is engaged by the liner engaging elements of a grapple tool 131 of the mill relining machine 130, the hydraulic fluid for supply to the actuator may be diverted from a hydraulic actuation function of the grapple tool 131.

It will be appreciated that this hydraulic diversion can allow the existing hydraulic system and control interface of the mill relining machine 130 and/or the grapple tool 131 to be used for controlling the operation of the liner gripping device 110 in use. In one example, in which the liner engaging elements of the grapple tool 131 include liner engaging pins, the actuator of the liner gripping device 110 may be supplied with hydraulic fluid that is diverted from a hydraulic actuation function of the grapple tool 131 that is normally for causing movement of the liner engaging pins 132, 133 for engaging with a new mill liner. In practice, this function may be initially used to cause the liner engaging pins 132, 133 to engage with the sockets 122, 123 of the interface 120 when coupling the liner gripping device 110 to the mill relining machine 130, and subsequently diverted for use in controlling the gripping operation of the liner gripping device 110.

FIG. 5 shows an example of an alternative version of a liner gripping device 520 which includes a rotator 540 that is operable to rotate the liner gripping device 110 relative to the mill relining machine 130. In this example, the liner gripping device 110 is the same as in previous examples, but the interface 520 has a different construction to provide the rotator 540 between the grapple tool 131 and the liner gripping device 110.

Providing a rotator 540 in this way permits a variable rotary position for the liner gripping device 110 and any worn mill liner gripped by its gripping members 112, 113 relative to the grapple tool 131 of the mill relining machine 130. It may be desirable to provide this rotation function within the interface 520 so that the rotation axis is aligned with the liner gripping device 110 to enable precise orientation of the gripping members 112, 113 when gripping a worn mill liner. The rotation will typically be configured to provide full 360° rotation of the liner gripping device 110.

In this case, a mounting plate 521 of the interface 520 is still attached to the device frame, but the rotator 540 is attached to it, with the features for interfacing with the grapple tool 131 being attached to the other side of the rotator 540. However, this example of the interface 520 still provides sockets 522, 523, and first and second reaction surfaces 524, 525 which are respectively engaged by the liner engaging pins 132, 133, reaction foot 134 and opposing rigid surface 135 of the grapple tool 111, in a similar manner as described above.

In some implementations of the above discussed example, the rotator 540 may hydraulically powered, and may be supplied with hydraulic fluid that is diverted from a hydraulic rotation function of the mill relining machine 130 or its grapple tool 131, in a manner similar to the diversion of the hydraulic actuation function for the actuator of the liner gripping device 110.

It will be appreciated that these hydraulic diversions allow the mill relining machine 130 to be adapted to support the additional functions of the system 100, without the need for providing new hydraulic lines or controls for operating the liner gripping device 110 or rotating it relative to the mill relining machine 130 in use.

It should be appreciated that, in some embodiments, the rotation functionality may be remotely located on the grapple tool 131. Instances exist where a mill relining machine 130 will have a rotation function on the grapple tool 131 as the last axis prior to the connection point of the liner engagement pins 132, 133. In these instances there may be no need to provide an additional 360° rotator 540 on the interface 120. On the other hand, some other grapple tool 131 variations have a raise/lower function as the last axis of movement before the connection point of the liner engagement pins 132, 133, and these variations would require the addition of a rotator 540 with the interface 120.

Preferred implementations of the system 100 having a hydraulically powered actuator and/or rotator may include hydraulic safety mechanisms for preventing unintentional movement of functions such as the gripping operation of the liner gripping device 110.

In some embodiments, the system 100 may include one or more hydraulic counterbalance valves to prevent unintentional hydraulic movement of the liner gripping device 110 in use. In one example, the system 100 may include a first counterbalance valve connected to the actuator to ensure that, in the event of hydraulic hose failure, the gripping members 112, 113 can maintain a grip on a mill liner, unless hydraulic input pressure is applied by the operator.

In embodiments, such as the one shown in FIG. 5 where the interface 520 includes a rotator 540 that is operable to rotate the liner gripping device 110 relative to the mill relining machine 130 as discussed above, the system 100 may include a second counterbalance valve connected to the rotator 540 to ensure that, in the event of hydraulic hose failure, the liner gripping device 110 and any mill liner gripped by the gripping members 112, 113 cannot rotate, unless hydraulic input pressure is applied by the operator.

However, some hydraulically powered implementations of the rotator 540 may already provide a self-locking function to prevent rotation, depending on the style of drive employed in the actuator 540. In the instance where the rotator 540 does prevent rotation internally, a counterbalance valve may not be required to safeguard against unexpected rotation in the event of hose failure. Locking of the rotation function may also be provided to prevent the over rotation of a gripped mill liner, where momentum of the mill liner could otherwise cause continued rotation after hydraulic impulse has begun the motion.

The counterbalance valves may be connected to the actuator and the rotator 540 via steel hydraulic tubing to protect against potential hose failures downstream from the counterbalance valves.

Preferred implementations of the system 100 may also include hydraulic protection mechanisms for preventing damage to hydraulic componentry.

As shown in FIGS. 3A to 3E, embodiments of the system 100 may include one or more hydraulic fittings 301, 302 that are configured to be selectively connected to and disconnected from a hydraulic system of the mill relining machine 130 to provide hydraulic power to at least the actuator of the liner gripping device 110, but also to a rotator 540 in examples including same. Embodiments of the system 100 may include one or more in line hydraulic filter screens for substantially preventing contamination of the hydraulic system due to connection and disconnection of the hydraulic fittings.

The system 100 elements of the liner gripping device 110 and the interface 120, including the rotator if provided, may be disconnected from the mill relining machine 130 when not in use. During a period of time where the liner gripping device 110 and the interface 120 are disconnected, it is expected that the hydraulic fittings 301, 302 will collect debris from the air and the environment. When connecting hydraulic fittings 301, 302 with contamination on them there is high likelihood that contamination could be carried into the hydraulic system. This can be mitigated by incorporating the hydraulic filter screens into the system. In practice, the hydraulic filter screens may be incorporated into hydraulic manifolds used on the system 100.

Hydraulic quick connections may be used to attach and disconnect the hydraulic functions of the system 100 to and from the mill relining machine 130. The particular form of the connections may be selected to ensure ease of cleaning prior to connection and also the ability to connect while residual hydraulic pressure is contained within the hydraulic lines.

The system 100 may also be configured to provide additional functionalities for aiding in the removal of worn liners from the mill. The system 100 may further include a liner dislodging member for dislodging a mill liner from the mill. Such a liner dislodging member may be attached to the interface 120 or the liner gripping device 110 and extend outwardly so that it can be moved by the mill relining machine to engage with a mill liner and apply a force, such as to pry a worn mill liner away from a mill shell of the mill. A range of different configurations of liner dislodging members may be provided depending on the configurations of the mill liner and the mill, and in some examples these may be interchangeable to suit different requirements.

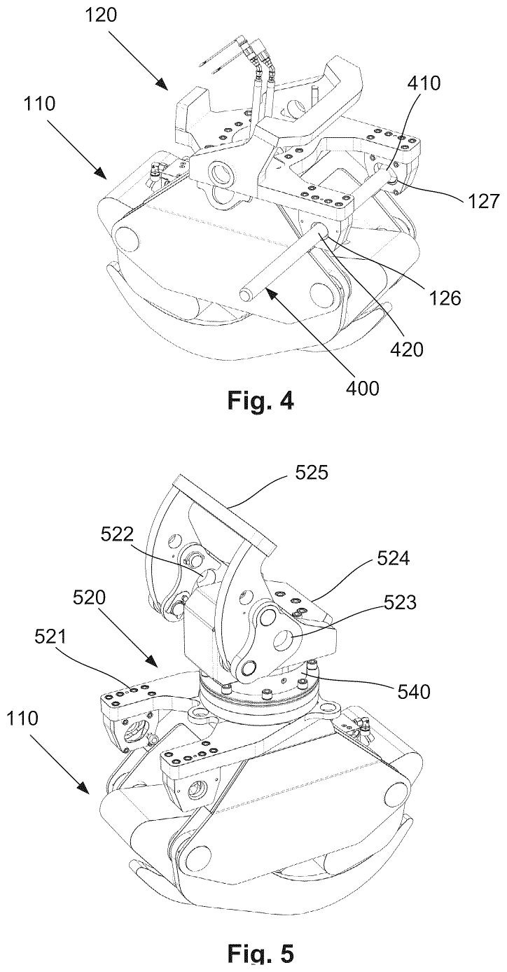

In one example, with regard to FIG. 4, the interface 120 may include first and second mounting blocks 126, 127 for installing a liner bolt 400 for use as a liner dislodging member, which can be particularly useful for dislodging a worn liner from the mill to allow its removal. In this example, the first mounting block 126 is configured to receive a threaded portion 420 of the liner bolt 400 and the second mounting block 127 is configured to receive a typically oval-shaped head 410 of the liner bolt 400, to thereby retain the liner bolt 400 relative to the liner gripping device 110.

In use, a liner bolt 400 must be inserted via the threaded end 420 through the first mounting block 126 from the centre of the interface 120 outwards until the bolt head 410 reaches a point where it can be aligned with the second mounting block 127. The head 410 of the liner bolt 400 is then moved into an oval-shaped head socket of the second mounting block 127 and twisted to a position where the head 410 is retained. Movement of the grapple tool 131 and subsequently the interface 120 then also moves the mounted liner bolt 400. The protruding threaded end 420 of the liner bolt 400 may be maneuvered such that it is engaged/socked into an exposed hole of a mill liner on the mill shell wall. Force applied to the interface 120 and subsequently the liner bolt 400 by the grapple tool 131 enables the dislodgement of liners from the mill shell wall. Dislodging of liners may cause the bending of the liner bolt 400. In such instances the bent liner bolt 400 may be removed from the mounting blocks 126, 127 and replaced by reversing the installation steps and inserting another liner bolt 400.

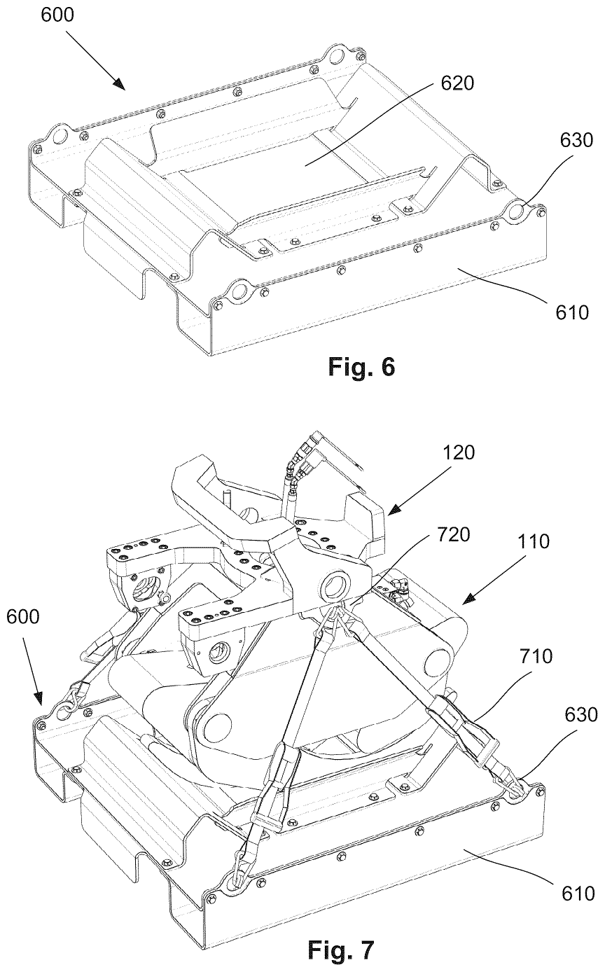

With regard to FIGS. 6 and 7, the liner gripping device 110 and the interface 120 may be configured to be stored on a transport tray 600 when detached from the mill relining machine, typically with the gripping members 122, 123 in a closed position. The transport tray 600 may include a tray frame 610 which defines a receptacle 620 into which the liner gripping device 110 can be placed while its gripping members 122, 123 are closed. The receptacle 620 may be shaped to ensure a defined position for the placement of the liner gripping device 110 to ensure correct centre of gravity position on the tray and no movement during transport. The liner gripping device 110 and the attached interface 120 can then be secured relative to the transport tray 600 by using tie-down straps 710 that are attached between tie-down points 630 on the tray frame 610 and tie-down rings 720 provided on the interface 120.

The transport tray 600 may be used to store the liner gripping device 110 and the interface 120 in any orientation that will allow them to fit into the mill opening and then be picked up by the grapple tool 131 of the mill relining machine 130. The liner gripping device 110 and the interface 120 are preferably stored in an upright position if the clear mill entry diameter allows for enough room (height) to convey the transport tray 600, the liner gripping device 110 and the interface 120 through the opening. Alternatively the liner gripping device 110 and the interface 120 may be positioned in such a way that the profile of the liner gripping device 110 and the interface 120 is minimised. The tray frame 610 may also include features to permit a forklift to engage with the transport tray 600 and move it onto a liner cart of the mill relining machine 130 prior to insertion through the mill entry.

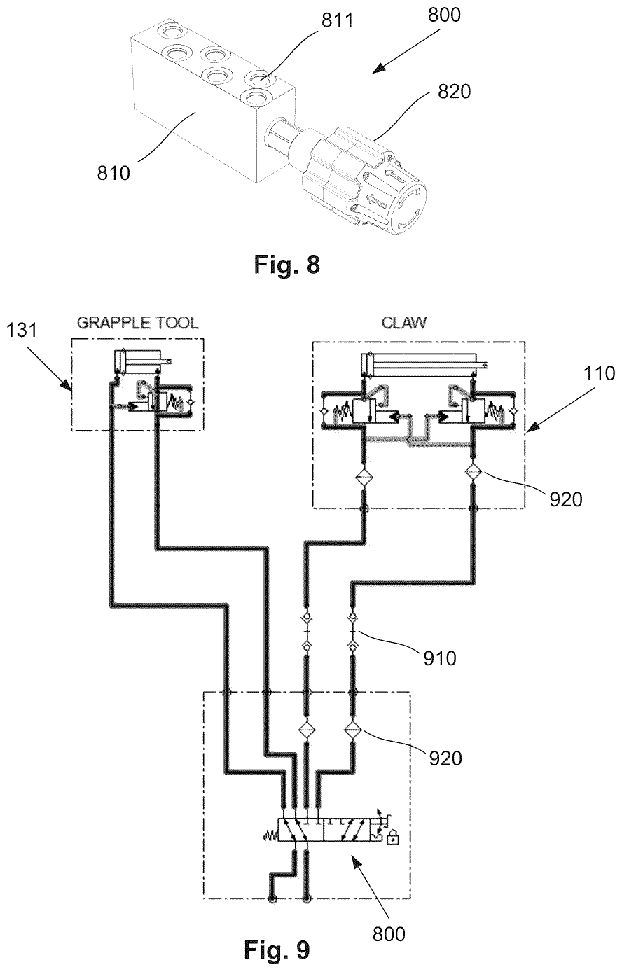

Further features of hydraulic functions of hydraulically powered embodiments of the system 100 will now be described with reference to FIGS. 8-10.

As discussed above, supply of hydraulic oil to the actuator of the liner gripping device 110 and the 360° rotator which may be optionally provided as part of the interface 120 may be achieved by diverting hydraulic flow from other mill relining machine 130 functions. Typically, these diverted functions have been determined to least affect the operational capability of the system 100.

The open/close function of the liner gripping device 110 may be operable via the same machine controls that operate the open/close function of the liner engagement pins 132, 133 of the grapple tool 131. In some implementations, this hydraulic function may incorporate a safety system that requires a two stage user input signal to open the gripping members 112, 113. For example, the safety system may require a button to be pressed on the mill relining machine 130 controls to indicate that the grapple tool 131 liner engagement pins 132, 133 or the gripping members 112, 113 are about to be opened. Within the space of a few seconds the hydraulic function to open the liner engagement pins 132, 133 or the gripping members 112, 113 may be utilised. In some implementations, if a predetermined amount of time (typically on the order of a few seconds) lapses before the function is utilised, the function becomes deactivated and cannot then be used until the initial button press is repeated.

The optional rotator 540 for providing the rotation function of the system 100 may be operable via the grapple tool 131 roll function for all 7 axis mill relining machines. In the instance of mill relining machines 130 having 8 axes, the 8^{th} axis function may be diverted to control the rotator 540. It should be appreciated that even though the mill relining machine 130 or its grapple tool 131 may already have a roll function, it may be desirable to provide the rotation function as part of the interface 120 so that the rotation axis is appropriately aligned with the liner gripping device 120, which might not be the case if rotation can only be provided using the mill relining machine 130 or its grapple tool 131.

Hydraulic diversion may be achieved via six-port selector valves 800, an example of which is shown in FIG. 8. In this example, the valve 800 includes a valve block 810, six ports 811 and a custom designed locking selection handle 820. Standard six-port selectors typically utilise a spring loaded twist handle to switch between functions. However, in this example, a locking function is added to the selection handle 820 that requires the operator to push on the selection handle 820 first and then twist to change the selection position. At either position the selection handle 820 locks itself via a spring loaded mechanism such that no twisting motion is possible without first applying a pushing force.

FIG. 9 shows an example of a hydraulic circuit in which a six-port selector valve 800 is used for selective hydraulic diversion of the open/close functionality of the grapple tool 131 liner engagement pins 132, 133 to control the open/close functionality of the liner gripping device 110. This example also shows where hydraulic counterbalance valves 910 and hydraulic filter screens 920 may be positioned in the hydraulic circuit.

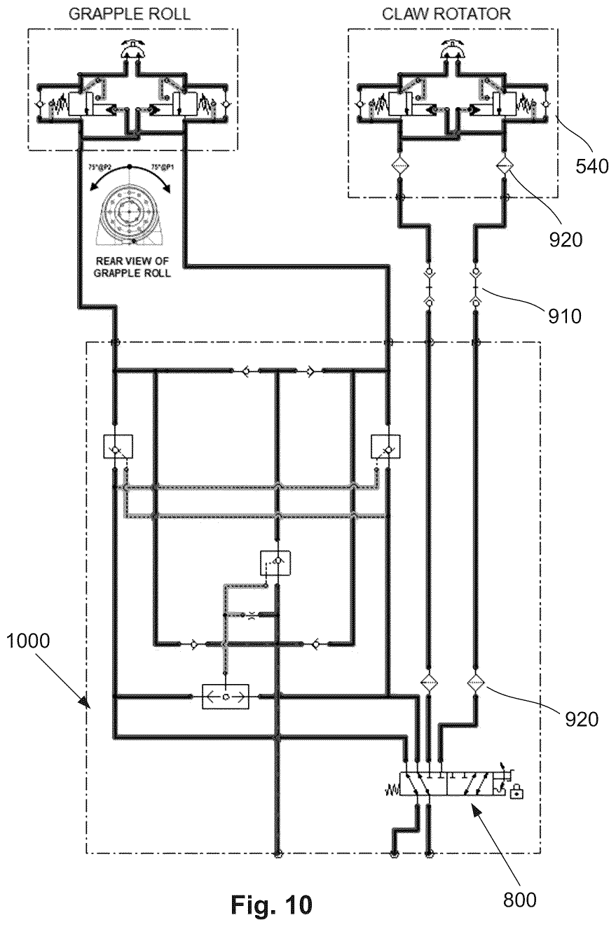

FIG. 10 shows another example of a hydraulic circuit in which another six-port selector valve 800 is used for selective hydraulic diversion of the roll functionality of the grapple tool 131 to control the operation of optional rotator 540 that can be used to rotate the liner gripping device 110. Once again, this example shows where hydraulic counterbalance valves 910 and hydraulic filter screens 920 may be positioned in the hydraulic circuit.

Hydraulic diversion from the grapple tool 131 roll function may in some cases require additional hydraulic safety mechanisms to prevent the build-up of hydraulic pressure inside isolated hydraulic circuits. A specialised hydraulic manifold 1000 may allow for the relief of excess pressure back through an additional tank line with negligible back pressure. The specialised manifold 1000 may be constructed in such a way that the relief of hydraulic oil is only possible when the hydraulic function is diverted and no oil pressure is applied to drive the inactive function. However, hydraulic build-up protection may not be needed when diverted functions contain internal relief mechanisms to prevent the build-up of excessive hydraulic pressure.

It will be appreciated that hydraulic diversion of other mill relining machine 130 functions, for instance as shown in the hydraulic circuits schematics of FIGS. 9 and 10, reduces the system complexity by reusing functions instead of increasing hydraulic line and valve count. However, alternative embodiments may not necessarily utilise hydraulic diversion, and may involve adding dedicated hydraulic circuits to control the opening/closing of the gripping members 112, 113 and rotation of the liner gripping device 120 in use.

Some mill relining machines 130 may utilise a radio control option for controlling all machine functions that would usually be controlled by an operator sitting on the machine operator's seat. If this system is used, the above discussed safety button for ensuring the grapple tool 131 and the gripping members 112, 113 do not open unexpectedly may still be provided but may need to function on a separate radio system from the main control, depending on local safety standards. For example, this would be necessary to achieve the electrical safety rating required to ensure safe operation of the mill relining machine 130 in Australia or in the European Union, although it may not be required in other jurisdictions. The radio control is not intended to be used when the mill relining machine 130 and the liner gripping device 110 are not visible to the operator. However it should be appreciated that operator visibility is not limited to line or sight vision but may be augmented using a suitable camera system including a display that effectively provides visibility of the operating area to the operator. In general, the radio control is not to be used to operate the system 100 when the operator is standing on the mill charge or in any position in close proximity to a load suspended by the liner gripping device 110.

An example of a method for moving a mill liner within a mill using the system 100 will now be discussed. As discussed above, the system 100 includes a liner gripping device 110 and an interface 120 that is used to detachably couple the liner gripping device 110 to a distal end of the mill relining machine 130, whereby the distal end of the mill relining machine 130 engages with the interface 120 to transmit forces between the mill relining machine 130 and the liner gripping device 110.

In the above context, the method includes, as an initial step, using the mill relining machine 130 to position the liner gripping device 110 relative to a mill liner within the mill. The method then involves operating an actuator of the liner gripping device 110 to move one or more gripping members 112, 113 of the liner gripping device 110 for gripping the mill liner. Finally, the method involves using the mill relining machine 130 to move the liner gripping device 110 and the mill liner gripped by the one or more gripping members 112, 113 within the mill.

The mill liner may be a worn liner that has been dislodged in a conventional manner by using a linerbolt removal tool to knock in the liner bolts from outside of the mill. It will be appreciated that, when the mill liner is a worn mill liner, the method may be used to move the worn mill liner to facilitate removal of the worn mill liner from the mill. The dislodging of a worn liner may optionally be assisted using a liner dislodging element that may be provided in some embodiments of the system 100 as discussed above.

The movement of the mill relining machine 130 throughout this method will typically be controlled by an operator using its standard operating controls, although in some examples this may be partially or fully automated. In some examples, automated functions may be provided for controlling the mill relining machine 130 and/or the liner gripping device 110 for some or all processes, including dislodging worn mill liners from the mill shell wall, gripping mill liners & moving mill liners, such as to a liner cart to facilitate their removal from the mill.

The operation of the actuator of the liner gripping device 110 will depend on how the actuator is powered, and if hydraulically powered, how the hydraulic fluid is supplied to the system. In some examples, dedicated hydraulic lines and controls may be provided for operating the hydraulic actuator of the liner gripping device 110.

As discussed above, the actuator of the liner gripping device 110 may be hydraulically powered and supplied with hydraulic fluid by diverting hydraulic flow from a hydraulic actuation function of the grapple tool 131. In such examples, the method may further include operating the actuator using the hydraulic actuation function. Accordingly, the operation of the liner gripping device 110 may also be controlled using the existing operating controls of the mill relining machine 130 and its grapple tool 131.

As also discussed above, some embodiments of the system 100 may include a rotator 540 (as shown in FIG. 5), and in such embodiments, the method may further include operating the rotator of the liner gripping device 110 to rotate the gripping members 112, 113 relative to the worn liner. The rotator 540 may also be hydraulically powered and supplied with hydraulic fluid by diverting hydraulic flow from a hydraulic rotation function of one of the grapple tool 131 and the mill relining machine 130, such that the method may include operating the rotator 540 using the hydraulic rotation function. This allows rotational movement of the liner gripping device 110 to also be controlled using the existing operating controls of the mill relining machine 130 and its grapple tool 131.

In implementations of the system 100 that have the interface 120 configured so that the liner engaging elements of the grapple tool 131 engage with the interface 120, the method may further include causing the liner engaging elements of the grapple tool 131 to engage with the interface 120 to couple the liner gripping device 110 to the mill relining machine 130.

As discussed above with regard to FIGS. 6 and 7, the liner gripping device 110 and the interface 120 may configured to be stored on a transport tray 600 when detached from the mill relining machine 130. With this in mind, the method may also include the following steps that are performed prior to using the mill relining machine 130 to position the liner gripping device 110. As an initial step, the method involves moving the detached liner gripping device 110 and interface 120 into the mill on the transport tray 600. Then, the method involves the mill relining machine 130 may be used to position the grapple tool 131 relative to the interface 120. Finally, the method involves causing the liner engaging elements of the grapple tool 131 to engage with the interface 120 to thereby couple the liner gripping device 110 to the mill relining machine 130.

In any event, it will be appreciated that embodiments of the system as described above can provide an improved solution for engaging with and lifting worn mill liners of variable shapes which have traditionally been difficult to handle. The system can be used to engage worn mill liners without misuse of mill relining machines and without sending personnel onto the mill charge with slings or chains. Hours of exposure to risk can be significantly reduced when using this system. Mill reline speed can also be improved, especially when using embodiments that are configured to allow the system functions to be operated by diverting functions of the mill relining machine, such that an operator can use the existing controls of the mill relining machine to facilitate removal of a worn mill liner.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means ±20%.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

It will of course be realised that whilst the above has been given by way of an illustrative example of this invention, all such and other modifications and variations hereto, as would be apparent to persons skilled in the art, are deemed to fall within the broad scope and ambit of this invention as is herein set forth.

1) A system for use in moving a mill liner within a mill, the system including:
a) a liner gripping device including:
i) a device frame;
ii) one or more gripping members that are moveable relative to the device frame; and
iii) an actuator that is operable to move the one or more gripping members for gripping a mill liner in use; and
b) an interface for detachably coupling the liner gripping device to a distal end of a mill relining machine to allow the liner gripping device to be moved using the mill relining machine, the interface being attached to the device frame and configured so that the distal end of the mill relining machine engages with the interface to transmit forces between the mill relining machine and the liner gripping device in use.

2) The system according to claim 1, wherein the distal end of the mill relining machine includes a grapple tool having liner engaging elements configured for engaging with a new mill liner, the interface being configured so that the liner engaging elements of the grapple tool engage with the interface.

3) The system according to claim 2, wherein the liner engaging elements of the grapple tool include liner engagement pins for engaging with lifting lugs of a new mill liner, the interface including sockets configured for receiving the liner engagement pins to thereby allow the grapple tool to at least partially engage with the interface.

4) The system according to claim 3, wherein the liner engaging elements of the grapple tool include a pair of liner engagement pins and a reaction foot for engaging with a surface of a new mill liner, the interface including a pair of sockets for receiving the pair of liner engagement pins and a first reaction surface for engaging with the reaction foot of the grapple tool.

5) The system according to claim 4, wherein the grapple tool further includes a rigid surface opposing the reaction foot, the interface further including a second reaction surface for engaging with the rigid surface of the grapple tool.

6) The system according to claim 3, wherein the liner engaging elements of the grapple tool include two pairs of liner engagement pins, the interface including two pairs of sockets for receiving the two pairs of liner engagement pins of the grapple tool.

7) The system according to any one of claims 1 to 6, wherein the liner gripping device is operable to provide an adjustable gripping width for producing a positive grip around worn mill liners having variable shapes.

8) The system according to any one of claims 1 to 7, wherein the one or more gripping members include opposing gripping members that are pivotally coupled to the device frame and moveable between a closed position and an open position.

9) The system according to claim 8, wherein the gripping members include a first gripping member including two or more fingers and a second gripping member including one or more fingers that interlock with the fingers of the first gripping member, when the gripping members are in the closed position.

10) The system according to claim 9, wherein one of:
a) the first gripping member includes two fingers and the second gripping member includes one finger;
b) the first gripping member includes two fingers and the second gripping member includes two fingers; and
c) the first gripping member includes three fingers and the second gripping member includes two fingers.

11) The system according to any one of claim 9 or claim 10, wherein each finger includes a liner engaging portion formed from a different material compared to a material forming the fingers.

12) The system according to claim 11, wherein the fingers are formed from steel and the liner engaging portions are formed from a material that is substantially softer compared to steel.

13) The system according to claim 11 or claim 12, wherein the liner engaging portions are formed from a resilient material.

14) The system according to any one of claims 11 to 13, wherein each liner engaging portion is provided as one of:
a) a component that is attached to a respective finger;
b) a sleeve that is fitted around a respective finger; and
c) a coating that is applied to a respective finger.

15) The system according to any one of claims 11 to 14, wherein each liner engaging portion is provided as a sacrificial component that can be replaced when worn.

16) The system according to any one of claims 1 to 15, wherein the one or more gripping members are at least one of:
a) adjustable in shape to suit mill liners of different shapes; and
b) interchangeable to allow different the use of different gripping members to suit mill liners of different shapes.

17) The system according to any one of claims 1 to 16, wherein the actuator of the liner gripping device is hydraulically powered and is supplied with hydraulic fluid that is diverted from a hydraulic actuation function of the mill relining machine.

18) The system according to any one of claims 3 to 6, wherein the actuator of the liner gripping device is hydraulically powered and is supplied with hydraulic fluid that is diverted from a hydraulic actuation function of the grapple tool being for causing movement of the liner engaging pins for engaging with a new mill liner.

19) The system according to any one of claims 1 to 18, wherein the interface includes a rotator that is operable to rotate the liner gripping device relative to the mill relining machine.

20) The system according to claim 19, wherein the rotator is hydraulically powered and is supplied with hydraulic fluid that is diverted from a hydraulic rotation function of one of the mill relining machine.

21) The system according to any one of claims 17 to 20, wherein the system includes one or more hydraulic counterbalance valves to prevent unintentional hydraulic movement of the liner gripping device in use.

22) The system according to claim 21, wherein the system includes a first counterbalance valve connected to the actuator to ensure that, in the event of hydraulic hose failure, the gripping members can maintain a grip on a mill liner, unless hydraulic input pressure is applied by the operator.

23) The system according to claim 22, wherein the first counterbalance valve is connected to the actuator via steel hydraulic tubing to protect against potential hydraulic hose failure downstream from the first hydraulic counterbalance valve.

24) The system according to claim 21, wherein the interface includes a hydraulically powered rotator that is operable to rotate the liner gripping device relative to the mill relining machine, the system including a second counterbalance valve connected to the rotator to ensure that, in the event of hydraulic hose failure, the liner gripping device and any mill liner gripped by the gripping members cannot rotate, unless hydraulic input pressure is applied by the operator.

25) The system according to any one of claims 17 to 24, wherein the system includes at least one of:
a) one or more hydraulic fittings that are configured to be selectively connected to and disconnected from a hydraulic system of the mill relining machine to provide hydraulic power to at least the actuator; and
b) one or more in line hydraulic filter screens for substantially preventing contamination of the hydraulic system due to connection and disconnection of the hydraulic fittings.

26) A system according to any one of claims 1 to 25, wherein the system further includes a liner dislodging member for dislodging a mill liner from the mill.

27) A system according to claim 26, wherein the interface includes first and second mounting blocks for installing a liner bolt for use as the liner dislodging member.

28) A system according to claim 27, wherein the first mounting block is configured to receive a threaded portion of a liner bolt and the second mounting block is configured to receive a head of the liner bolt to thereby retain the liner bolt relative to the liner gripping device.

29) A system according to any one of claims 1 to 28, wherein the liner gripping device and the interface are configured to be stored on a transport tray when detached from the mill relining machine.

30) A method for moving a mill liner within a mill, the method being performed using a system including a liner gripping device and an interface that is used to detachably couple the liner gripping device to a distal end of a mill relining machine, whereby the distal end of the mill relining machine engages with the interface to transmit forces between the mill relining machine and the liner gripping device, the method including:
a) using the mill relining machine to position the liner gripping device relative to a mill liner within the mill;
b) operating an actuator of the liner gripping device to move one or more gripping members of the liner gripping device for gripping the mill liner; and
c) using the mill relining machine to move the liner gripping device and the mill liner gripped by the one or more gripping members within the mill.

31) A method according to claim 30, wherein the mill liner is a worn mill liner and the method includes moving the worn mill liner to facilitate removal of the worn mill liner from the mill.

32) A method according to claim 30 or claim 31, wherein the actuator of the liner gripping device is hydraulically powered and is supplied with hydraulic fluid by diverting hydraulic flow from a hydraulic actuation function of the mill relining machine, the method including operating the actuator using the hydraulic actuation function.

33) The method according to claim 32, wherein the method further includes operating a rotator of the system to rotate the gripping members relative to the worn liner.

34) The method according to claim 33, wherein the rotator of the system is hydraulically powered and is supplied with hydraulic fluid by diverting hydraulic flow from a hydraulic rotation function of the mill relining machine, the method including operating the rotator using the hydraulic rotation function.

35) A method according to any one of claims 30 to 34, wherein the distal end of the mill relining machine includes a grapple tool having liner engaging elements configured for engaging with a new mill liner, the method including causing the liner engaging elements of the grapple tool to engage with the interface to couple the liner gripping device to the mill relining machine.

36) The method according to claim 35, wherein the liner gripping device and the interface are configured to be stored on a transport tray when detached from the mill relining machine, the method including, prior to using the mill relining machine to position the liner gripping device:
a) moving the liner gripping device and interface into the mill on the transport tray;
b) using the mill relining machine to position the grapple tool relative to the interface; and
c) causing the liner engaging elements of the grapple tool to engage with the interface to couple the liner gripping device to the mill relining machine.
